(19) United States
(12) Patent Application Publication
(10) Pub. No.: US 2014/0012660 A1
(43) Pub. Date: Jan. 9, 2014

(54) METHOD AND SYSTEM FOR COMPARING ONLINE ADVERTISING PRODUCTS

(71) Applicant: Yahoo! Inc., Sunnyvale, CA (US)

(72) Inventors: Sai-Ming Li, Santa Clara, CA (US); Jack Xie, San Francisco, CA (US)

(73) Assignee: Yahoo! Inc., Sunnyvale, CA (US)

(21) Appl. No.: 13/973,665

(22) Filed: Aug. 22, 2013

Related U.S. Application Data
(62) Division of application No. 12/570,883, filed on Sep. 30, 2009.

(51) Int. Cl. G06Q 30/02

(52) U.S. Cl. CPC G06Q 30/0243
USPC 705/14.42

(57) ABSTRACT

A method in a networked system for comparing advertising products includes a processor configured to sampling an impression inventory database to produce a first set of impression samples represented by a first product, and a second set of impression samples represented by a second product. The processor is also configured to determine the percentage of the first set of impression samples that are represented by a second product and also the percentage of the second set of impression samples that are represented by the first product. The processor selects the minimum percentage of the two percentages, where the minimum percentage defines the similarity between the first product and the second product.

### CROSS-REFERENCE TO RELATED APPLICATION

This is a divisional of application Ser. No. 12/570,883 filed on Sep. 30, 2009, the contents of all of which are hereby incorporated herein by reference in their entirety.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

To facilitate advertisement placement, web site operators may provide systems that allow an advertiser to book a number of impressions (i.e., the displaying of an advertisement) that target users characterized by different attributes. Web site operators typically refer to different collections or groups of impression inventory as products. For example, a first product may correspond to males that live in California and a second product may correspond to females in California. Yet a third product may correspond to all individuals in California. After booking, advertisements from the advertiser are served to web sites that target the audience specified by the product.

When booking impressions, an advertiser may be provided with a list of products from which to choose. For example, the advertiser may select a product that targets males in California and book a number of impressions from that product. A cost or a method for calculating a cost for booking impressions from that product may have been previously determined.

Sometimes an advertiser may want to purchase a product that is not on the list of existing products. The advertiser can do so by specifying a list of targeting attributes that characterize the desired product. The advertisements may then be served to users that match the targeting characteristics. The cost associated with serving ads in this case may be based on factors, such as the scarcity of the impressions or what other advertisers are willing to pay for the impressions.

One problem with the second scenario is that it may not be obvious what the custom product should cost. This allows some sophisticated advertisers to purchase desirable impressions without booking any existing products even though a product that targets the desired audience may exist. This, in turn, may allow the advertiser to book the desired impressions for a lower cost and ultimately results in lower revenues for the web site operator.

### BRIEF DESCRIPTION OF THE DRAWINGS

FIG. 1 is a system 100 for booking impressions from an inventory of impressions;

FIG. 2 illustrates a first exemplary group of operations performed by the processor and/or admission control system when an order is booked;

FIG. 3 is a graphical representation showing the similarity between products;

FIG. 4 is a first methodology for determining the similarity of different products;

FIG. 5 is a second methodology for determining the similarity of different products; and

FIG. 6 illustrates a general computer system, which may represent any of the computing devices referenced herein.

### DETAILED DESCRIPTION

The embodiments below describe a system for booking impressions from an inventory of impressions. Generally, advertiser's book impression from existing products, such as a product that corresponds to a group of impressions that target a specific audience, or book impressions based on target attributes. In some implementations, the system treats the targeting attributes as a new product with a description that matches the target attributes. Generally, the system determines the cost for booking impression from the new product by determining whether impressions associated with the new product fall into one or more existing products.

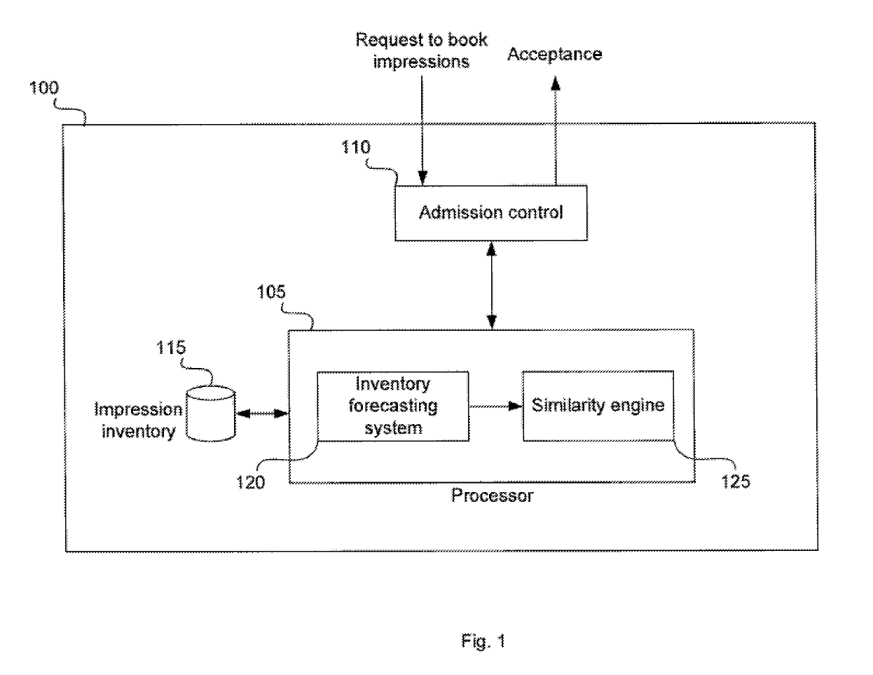

FIG. 1 is a system 100 for booking impressions from an inventory of impressions. The system 100 includes an admission control subsystem 110, a processor 105, and an impression inventory database 115. The various components of the system 100 may reside on a single computer or be distributed between several computers interconnected by a communication network.

The processor 105 may correspond to an Intel®, AMD®, or PowerPC® based processor operating a Microsoft Windows®, Linux, or other Unix® based operating system. The processor 105 may be configured to communicate with other computers via an interface, such as a network interface. The processor 105 may be configured to communicate data to and from the impression inventory database 115 and/or other components.

The processor 105 includes an inventory forecasting subsystem 120 and a similarity engine 125. The inventory forecasting subsystem 120 may correspond to code, logic, and/or other circuitry configured to forecast the number impressions available at a future date. In some implementation, the forecasting subsystem 120 analyzes impressions stored in the impression inventory database to forecast further impression availability.

The similarity engine 125 may correspond to code, logic, and other circuitry configured to determine the similarity between products that define groups of impression. Operations of the similarity engine 125 are described in more detail below.

The impression inventory database 115 may correspond to a data storage device suitable for storing large amounts of information, such as RAM, ROM, or hard disk drives. The impression inventory database 115 may store information related to impressions that were delivered in the past. This may enable the forecasting subsystem 120 to forecast the number of impressions available in the future. Generally, information stored in the impression inventory database 115 may be based on advertisements served via one or more ad servers (not shown). For example, an ad server may communicate to the processor 105 that an impression was delivered. The processor 105 may then store information defining that impression to the impression inventory database 115.

Each impression may be characterized by attributes, such as user information, property information, position on the property, and/or other information. The user information includes data that defines characteristics of a user associated with an impression. For example, the user information may include the gender, age, and geographic information associated with the user. The property information defines the web site or web page through which an impression was delivered. For example, the property information may correspond to a sponsored search web site, such a Yahoo! Search®, or email web site, such as Yahoo! Mail®. The position information corresponds to the location on the property where the impression was located, such as the top, bottom or side of a web page.

The admission control subsystem 110 may include logic, circuitry, and/or code that enables an advertiser to book impressions. Generally, the admission control subsystem 110 allows an advertiser to book impressions from a product or by specifying targeting attributes. Each product represents a collection of impressions in the impression inventory database 115 that share one or more of the characterization attributes described above. For example, a first product may represent impressions deliverable to males in California and a second product may represent impressions deliverable to National Football League (NFL) fans. The number of available impressions for a given product may be based on information stored in the impression inventory database 115. In some cases, a given impression may be represented by several products. For example, an impression that represents a male user in California who is an NFL fan may be represented by the first product, because the user is a male in Californian, and by the second product, because the user is an NFL fan.

To facilitate booking, the admission control subsystem 110 may be configured to communicate a web page to an advertiser that allows the advertiser to specify a product description. The web page may enable specifying the quantity of impressions sought along with information that defines the product description or the targeting attributes. In addition, the web page may enable uploading an advertisement and specifying the desired property or properties and position on the properties where the advertiser desires to place the advertisement. Once booked, impressions associated with the product may be marked as unavailable in the impression inventory database 115.

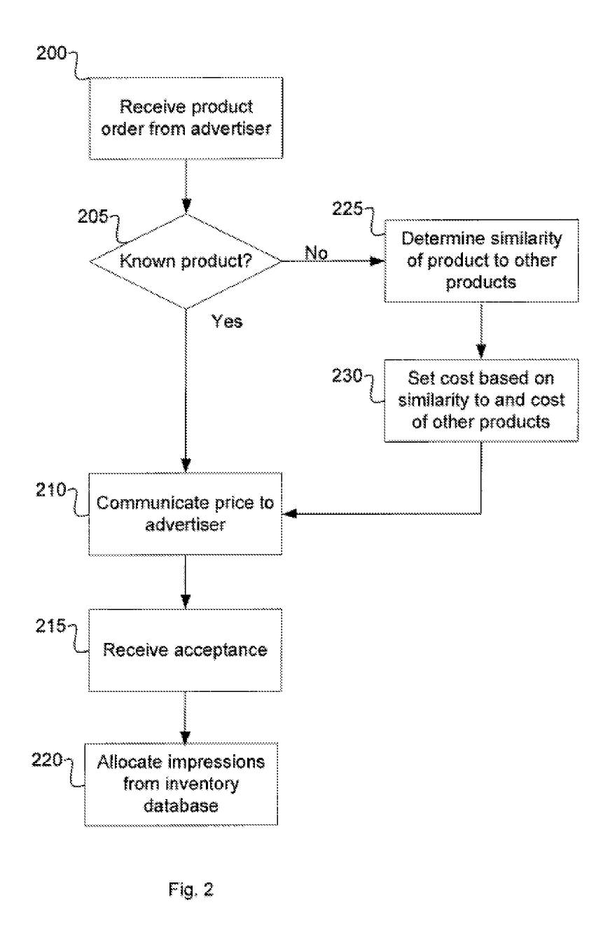

FIG. 2 illustrates a first exemplary group of operations performed by the processor and/or admission control system when an order is booked. At block 200, an order for booking impressions may be communicated to the system 100 (FIG. 1). For example, an advertiser may, via an order web page, place an order to book a number of impressions. In some instances, the advertiser may be presented with a list of products from which impressions may be purchased. The products may represent groups of impressions associated with users that share one or more characterization attributes. In other instances, the advertiser may specify a list of characterization attributes that characterize the impressions sought.

At block 205, if an existing product is specified, then at block 210, the cost associated with the existing product may be communicated to the advertiser. For example, the cost associate with a product that target sports enthusiast may already be known because many advertiser may order impressions from that product. The cost may specify a money amount per impression, per 1000 impressions, etc. The cost may also be based on a current bid amount that other advertisers are willing to spend.

At block 215, an acceptance of the order may be communicated from the advertiser to the system 100. For example, the advertiser may accept the order if the advertiser agrees with the cost for booking the impressions.

At block 220, impressions represented by the product may be allocated from the impression inventory database.

If at block 205, an advertiser specifies targeting attributes rather than a known product description, then at block 225, the targeting attributes may be treated as a new product description, where the cost for booking impressions is unknown. The similarity between impressions represented by the new product and impressions represented by existing products for which a cost is known may be compared. Exemplary methodologies for determining the similarity of the products is described below.

At block 230, the cost for the new product may be determined and communicated to the advertiser at block 210, described above. The cost may be based on the new products similarity to existing products and the cost of those existing products. For example, the cost may correspond to a weighted average cost that weighs the cost of each existing product by that products similarity to the new product. The weighted average cost may then be communicated to the advertiser at block 210.

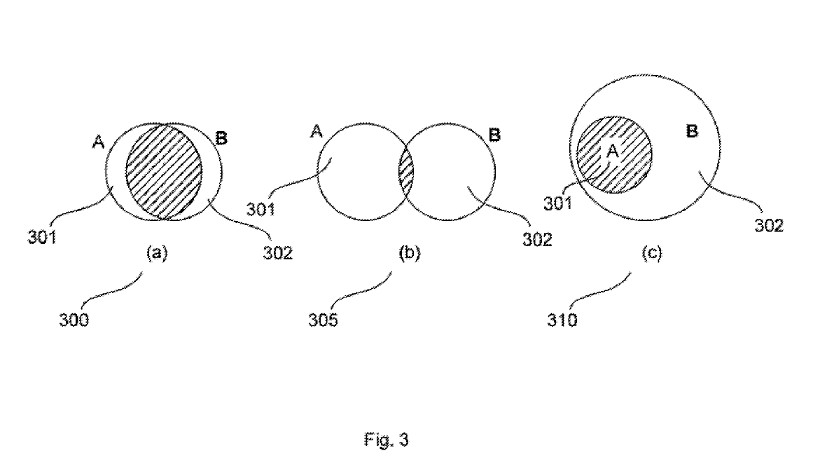

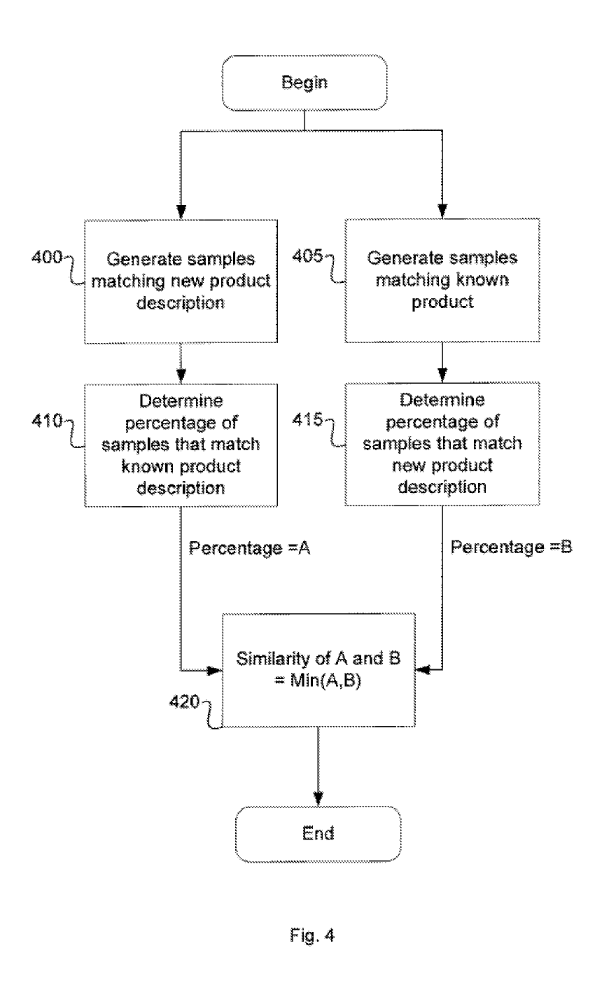

FIG. 3 is a graphical representation showing the similarity between products that represent impressions and FIG. 4 is a first methodology for determining the similarity of different products that represent impressions. In FIG. 3, circle A 301 and circle B 302 represent the set of eligible inventory of for product A and product B, respectively. In case (a) 300, product A 301 and product B 302 have significant overlap in their eligible inventory and are, therefore, similar to each other. That is, most of the impressions that fall into product A 301 also fall into product B 302. Case (b) 305 illustrates the opposite case, where the product A 301 and product B 302 are not similar to each other. That is, few impressions fall into both products A 301 and product B 302. In case (c) 310, product A 301 is a subset of the product B 302. In this case, all the impressions associated with product A 301 are also part of product B 302. But the opposite is not true. That is, most of the impressions that are part of product B 302 are not part of product A 301. Therefore, product A and product B are dissimilar.

FIG. 4 is a first methodology for determining the similarity of different products. At block 400, samples of impressions that are represented by a new product description may be taken. For example, an inventory forecasting engine 120 (FIG. 1) may retrieve samples for an impression inventory database 115 (FIG. 1). The impressions may be associated with users that are characterized by targeting attributes specified in the product description.

At block 405, samples of impressions that are represented by an existing product description may be taken. For example, the inventory forecasting engine 120 may retrieve samples for the impression inventory database 115. The impressions may be associated with users that are characterized by targeting attributes associated with a product with an existing product description.

At block 410, the percentage of samples from block 400 that are also represented by an existing product is determined. For example, a similarity engine 125 (FIG. 1) in communication with the forecasting engine 120 may analyze characterization attributes associated with each impression sample to determine whether the impression sample is also represented by the existing product.

At block 415, the percentage of samples from block 405 that are represented by the new product is determined. For example, the similarity engine 125 may analyze characterization attributes associated with each impression sample to determine whether the impression sample is also represented by the new product.

At block 420, the minimum of the percentages calculated in block 410 and block 415 is determined. If the result is a high percentage, then the new product is essentially the same as the existing product. This is the situation that occurs in case (a) 300 of FIG. 3. A lower percentage indicates that the new product is very dissimilar to the existing product. This is the situation illustrated in case (b) 305 of FIG. 3. The similarity of the products may be utilized to set the cost associated with the new product. For example, if the new product is very similar to an existing product with an associated cost, the same cost may be utilized for the new product.

However, in some instances, it may be desirable to compare a new product description with several existing products as the new product may be more similar to some products than others. In this case, the operations above may be repeated for all existing products. However, in some instances, it may not be possible to perform the comparisons in real-time or within the time that an advertiser expects an answer to his order.

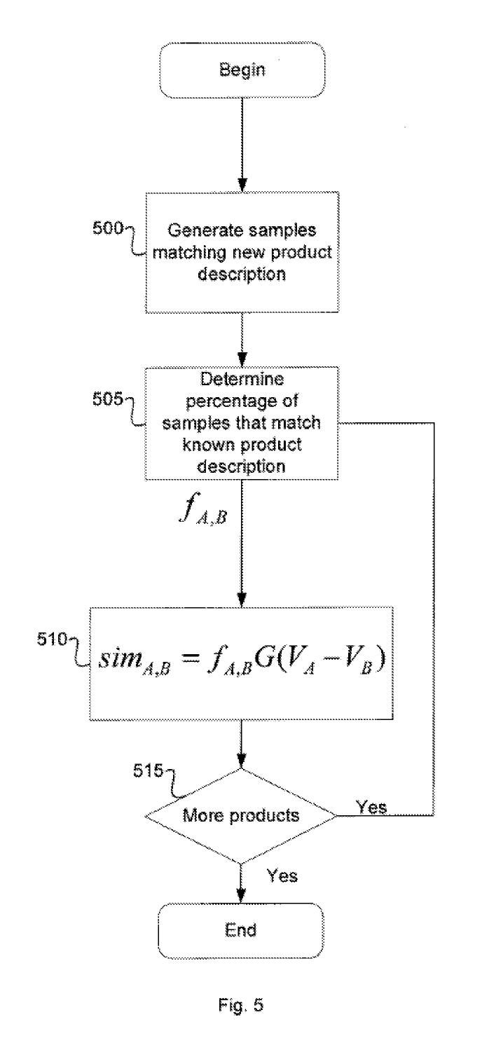

FIG. 5 is a second methodology for determining the similarity of different products. The operations in FIG. 5 enable efficiently comparing a new product description with multiple existing product descriptions.

At block 500, samples of impressions that match a new product description may be taken. For example, an inventory forecasting engine 120 (FIG. 1) may retrieve samples for an impression inventory database 115 (FIG. 1). The impressions may be associated with users that are characterized by targeting attributes specified in the product description.

At block 505, the percentage of samples from block 500 that are represented by an existing product is determined. For example, a similarity engine 125 (FIG. 1) in communication with the forecasting engine 115 may analyze characterization attributes associated with each impression sample to determine whether impression samples are represented by an existing product.

At block 510, the similarity of the new product is compared to the existing product. The similarity of the products may correspond to a function of the percentage calculated in block 505, the total amount of impression inventory that matches the first product description, and the total amount of inventory that matches the second product description. For example, the similarity may be computed according to the following equation:

sim_{A,B}=f_{A,B}G(V_{A}−V_{B}),

where
A represents products related to the first product description,
B represents products related to the second product description,

$${f}_{A , B} = \frac{{m}_{A , B}}{n} ,$$

m_{A,B} corresponds to the number of samples in the first set of inventory samples that match the second product description,
n corresponds to the number of samples in the first set of inventory samples,
G is a Gaussian function with zero mean and standard deviation a,
V_{A} is the total amount of inventory that matches the first product description, and
V_{B} is the total amount of inventory that matches the second product description.

G(x) may correspond to the following Gaussian equation:

$$G ( x ) = \frac{exp ( - {x}^{2} / 2 {σ}^{2} )}{σ \sqrt{2 π}}$$

The total amount of inventory that matches the product description of all existing products may be computed offline and stored for later retrieval or computed in real-time when an order is placed.

At block 515, if there are additional existing products to compare with the new product, then the operations from block 505 repeat. The operations stop when all the existing products have been compared to the new product.

The second methodology enables determine the similarity between a new product and a number of existing products more efficiently than is accomplished via the first methodology. This in turn enables real-time or near real-time determination of the similarity of the new product to many other products when processing an order from an advertiser.

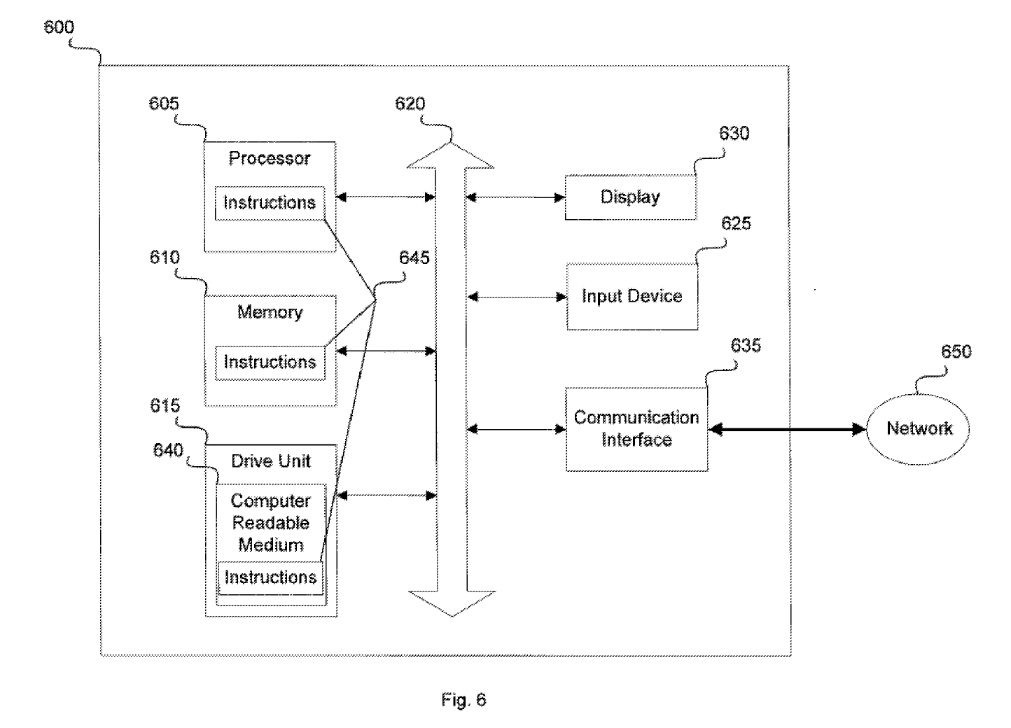

FIG. 6 illustrates a general computer system 600, which may represent the admission control subsystem 110, the processor 125, the inventory forecasting system 120, and/or the similarity engine 125 of FIG. 1, or any other computing devices referenced herein. The computer system 600 may include a set of instructions 645 that may be executed to cause the computer system 600 to perform any one or more of the methods or computer-based functions disclosed herein. The computer system 600 may operate as a stand-alone device or may be connected, e.g., using a network, to other computer systems or peripheral devices.

In a networked deployment, the computer system 600 may operate in the capacity of a server or as a client-user computer in a server-client user network environment, or as a peer computer system in a peer-to-peer (or distributed) network environment. The computer system 600 may also be implemented as or incorporated into various devices, such as a personal computer or a mobile device, capable of executing a set of instructions 645 (sequential or otherwise) that specify actions to be taken by that machine. Further, each of the systems described may include any collection of sub-systems that individually or jointly execute a set, or multiple sets, of instructions to perform one or more computer functions.

The computer system 600 may include a memory 610 on a bus for communicating information. The impression inventory database 115 may be stored in the memory 610. In addition, code operable to cause the computer system to perform any of the acts or operations described herein may be stored in the memory 610. The memory 610 may be a random-access memory, read-only memory, programmable memory, hard disk drive or any other type of memory or storage device.

The computer system 600 may include a display 630, such as a liquid crystal display (LCD), a cathode ray tube (CRT), or any other display suitable for conveying information. The display 630 may act as an interface for the user to see the functioning of the processor 605, or specifically as an interface with the software stored in the memory 610 or in the drive unit 615.

Additionally, the computer system 600 may include an input device 625, such as a keyboard or mouse, configured to allow a user to interact with any of the components of system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the operations as described herein. The instructions 645 may reside completely, or at least partially, within the memory 610 and/or within the processor 605 during execution by the computer system 600. The memory 610 and the processor 605 also may include computer-readable media as discussed above.

The computer system 600 may include a communication interface 635 that enables communications via a network 650. The network 650 may include wired networks, wireless networks, or combinations thereof. The communication interface 635 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system enables determining a cost associate with a new product or a set of targeting attributes specified by an advertiser when booking an order. Generally, the system takes samples of impressions from an impression inventory database that match the targeting attributes or new product description and determines whether the samples are represented by other products for which a booking cost is known. If an existing product is similar, the cost associated with existing product may be utilized as the basis of the cost for booking impression from the new product.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A system for comparing advertising products, the system comprising:
an inventory forecasting system configured to sample an impression inventory database to produce a first set of impression samples, the first set of impression samples being represented by a first product;
a similarity engine configured to determine a percentage of the first set of impressions that are represented by a second product and to determine a similarity between the first product and the second product according to the following equation:
sim_{A,B}=f_{A,B}G(V_{A}−V_{B}),
where
A represents the first product,
B represents the second product,
$${f}_{A , B} = \frac{{m}_{A , B}}{n} ,$$
m_{A,B} corresponds to the number of impression samples in the first set of impression samples that are represented by the second product,
n corresponds to the number of impression samples in the first set of impression samples,
G is a Gaussian function with zero mean and standard deviation σ,
V_{A} is the total number of impressions represented by the first product, and
V_{B} is the total number of impressions represented by the second product;
circuitry and logic configured to store data that defines the similarity between the first product and second product to a database; and
a display configured to display the stored data.

2. The system according to claim 1, wherein G(V_{A}−V_{B}) corresponds to the following equation:
$$G ( x ) = \frac{exp ( - {x}^{2} / 2 {σ}^{2} )}{σ \sqrt{2 π}}$$
where, x=V_{A}−V_{B}.

3. The system according to claim 1, wherein each impression in the impression inventory database represents an advertising impression to be communicated to a user via the networked environment.

4. The system according to claim 1, wherein a first product description characterizes impressions represented by the first product and a second product description characterizes impression represented by the second product.

5. The system according to claim 1, wherein the percentage is a first percentage, the similarity is a first similarity, and the similarity engine is further configured to:
sample an impression inventory database to produce a second set of impression samples, the second set of impression samples being represented by the second product; and
determine a second percentage of the second set of impressions that are represented by the first product and to determine a second similarity between the first product and the second product according to the following equation:
sim_{A′,B′}=f_{A′,B′}G(V_{A′}−V_{B′}),
where
A′ represents the second product,
B′ represents the first product,
$${f}_{{A}^{,} , {B}^{,}} = \frac{{m}_{{A}^{,} , {B}^{,}}}{{n}^{,}} ,$$
m_{A′,B′} corresponds to the number of impression samples in the second set of impression samples that are represented by the first product,
n′ corresponds to the number of impression samples in the second set of impression samples,
G is a Gaussian function with zero mean and standard deviation a,
V_{A′} is the total number of impressions represented by the second product, and
V_{B′} is the total number of impressions represented by the first product.

6. The system according to claim 5, wherein the similarity engine is further configured to calculate a minimum percentage between the first percentage and the second percentage.

7. The system according to claim 5, wherein the similarity engine is further configured to price the second set of impressions according to the first percentage if the first percentage is lower than the second percentage or according to the second percentage if the second percentage is lower than the first percentage.

8. A non-transitory storage medium having stored thereon a computer program comprising at least one code section for comparing advertising products, the at least one code section being executable by a machine for causing the machine to perform acts of:
sampling an impression inventory database to produce a first set of impression samples, the first set of impression samples being represented by a first product;
determining a percentage of the first set of impressions that are represented by a second product and to determine a similarity between the first product and the second product according to the following equation:
sim_{A,B}=f_{A,B}G(V_{A}−V_{B}),
where
A represents the first product,
B represents the second product,
$${f}_{A , B} = \frac{{m}_{A , B}}{n} ,$$
m_{A,B} corresponds to the number of impression samples in the first set of impression samples that are represented by the second product,
n corresponds to the number of impression samples in the first set of impression samples,
G is a Gaussian function with zero mean and standard deviation a,
V_{A} is the total number of impressions represented by the first product, and
V_{B} is the total number of impressions represented by the second product;
storing data that defines the similarity between the first product and second product to a database; and
displaying the stored data.

9. The non-transitory storage medium according to claim 8, wherein G(V_{A}−V_{B}) corresponds to the following equation:
$$G ( x ) = \frac{exp ( - {x}^{2} / 2 {σ}^{2} )}{σ \sqrt{2 π}}$$
where, x=V_{A}−V_{B}.

10. The non-transitory storage medium according to claim 8, wherein each impression in the impression inventory database represents an advertising impression to be communicated to a user via the networked environment.

11. The non-transitory storage medium according to claim 8, wherein a first product description characterizes impressions represented by the first product and a second product description characterizes impression represented by the second product.

12. The non-transitory storage medium according to claim 8, wherein the percentage is a first percentage, the similarity is a first similarity, and the at least one code section is further executable by a machine for causing the machine to perform:
sampling an impression inventory database to produce a second set of impression samples, the second set of impression samples being represented by a second product;
determining a second percentage of the second set of impressions that are represented by the first product and to determine a second similarity between the first product and the second product according to the following equation:
sim_{A′,B′}=f_{A′,B′}G(V_{A′}−V_{B′})
where
A′ represents the second product,
B′ represents the first product,
$${f}_{{A}^{,} , {B}^{,}} = \frac{{m}_{{A}^{,} , {B}^{,}}}{{n}^{,}} ,$$
m_{A′,B′} corresponds to the number of impression samples in the second set of impression samples that are represented by the first product,
n′ corresponds to the number of impression samples in the second set of impression samples,
G is a Gaussian function with zero mean and standard deviation a,
V_{A′} is the total number of impressions represented by the second product, and
V_{B′} is the total number of impressions represented by the first product; and
storing data that defines the second similarity between the first product and second product to a database.

13. The non-transitory storage medium according to claim 12, wherein the at least one code section is further executable by a machine for causing the machine to perform: calculating a minimum percentage between the first percentage and the second percentage.

14. The non-transitory storage medium according to claim 12, wherein the at least one code section is further executable by a machine for causing the machine to perform: pricing the second set of impressions according to the first percentage if the first percentage is lower than the second percentage or according to the second percentage if the second percentage is lower than the first percentage.

15. A method for comparing advertising products, the method comprising:
sampling, by a processor, an impression inventory database to produce a first set of impression samples, the first set of impression samples being represented by a first product;
determining, by the processor, a percentage of the first set of impressions that are represented by a second product;
storing, by the processor, data that defines a similarity between the first product and second product to a database, wherein the similarity between the first product and the second products is determined by a processor according to the following equation:
sim_{A,B}=f_{A,B}G(V_{A}−V_{B})
where
A represents the first product,
B represents the second product,
$${f}_{A , B} = \frac{{m}_{A , B}}{n} ,$$
m_{A,B} corresponds to the number of impression samples in the first set of impression samples that are represented by the second product,
n corresponds to the number of impression samples in the first set of impression samples,
G is a Gaussian function with zero mean and standard deviation a,
V_{A} is the total number of impressions represented by the first product, and
V_{B} is the total number of impressions represented by the second product; and
displaying, by a display communicatively coupled to the processor, the data that defines a similarity between the first product and second product.

16. The method according to claim 15, wherein G(V_{A}−V_{B}) corresponds to the following equation:
$$G ( x ) = \frac{exp ( - {x}^{2} / 2 {σ}^{2} )}{σ \sqrt{2 π}}$$
where, x=V_{A}−V_{B}.

17. The method according to claim 15, wherein each impression in the impression inventory database represents an advertising impression to be communicated to a user via the networked environment.

18. The method according to claim 15, wherein a first product description characterizes impressions represented by the first product and a second product description characterizes impressions represented by the second product.

19. The method according to claim 15, wherein the percentage is a first percentage, the similarity is a first similarity, and the method further comprises:
sampling an impression inventory database to produce a second set of impression samples, the second set of impression samples being represented by a second product;
determining a second percentage of the second set of impressions that are represented by the first product and to determine a second similarity between the first product and the second product according to the following equation:
sim_{A′,B′}=f_{A′,B′}G(V_{A′}−V_{B′})
where
A′ represents the second product,
B′ represents the first product,
$${f}_{{A}^{,} , {B}^{,}} = \frac{{m}_{{A}^{,} , {B}^{,}}}{{n}^{,}} ,$$
m_{A′,B′} corresponds to the number of impression samples in the second set of impression samples that are represented by the first product,
n′ corresponds to the number of impression samples in the second set of impression samples,
G is a Gaussian function with zero mean and standard deviation a,
V_{A′} is the total number of impressions represented by the second product, and
V_{B′} is the total number of impressions represented by the first product; and
storing data that defines the second similarity between the first product and second product to a database.

20. The method according to claim 19, further comprising pricing the second set of impressions according to the first percentage if the first percentage is lower than the second percentage or according to the second percentage if the second percentage is lower than the first percentage.
